(19) United States
(12) Patent Application Publication
(10) Pub. No.: US 2017/0083487 A1
(43) Pub. Date: Mar. 23, 2017

(54) WEBPAGE DATA PROCESSING METHOD AND DEVICE

(71) Applicant: SHENZHEN SKYWORTH-RGB ELECTRONIC CO., LTD., Shenzhen, Guangdong (CN)

(72) Inventors: Zhiguo Wang, Shenzhen, Guangdong (CN); Xia Tan, Shenzhen, Guangdong (CN); Quanqing Liang, Shenzhen, Guangdong (CN)

(21) Appl. No.: 15/125,965

(22) PCT Filed: Oct. 23, 2014
(86) PCT No.: PCT/CN2014/089244

§ 371 Date: Sep. 13, 2016

(30) Foreign Application Priority Data
Sep. 26, 2014 (CN) 201410500228.7

(51) Int. Cl. G06F 17/22; G06F 3/14; G06F 17/21; G06F 17/30

(52) U.S. Cl. CPC G06F 17/2247; G06F 17/30876; G06F 17/3089; G06F 3/14; G06F 17/218; G06F 17/2235; G06F 17/2288

(57) ABSTRACT

Disclosed is a webpage data processing method, including the steps of: a first display terminal sends a webpage link request to a server to obtain webpage content included in the webpage link; the first display terminal classifies the obtained webpage content according to the type of the webpage content into a first preset type of webpage content and a second preset type of webpage content; the first display terminal outputs the first preset type of webpage content to a second display terminal for display; the first display terminal displays the second preset type of webpage content. Also disclosed is a webpage data processing device. The webpage data processing method of the present invention enables text content of a webpage to be browsed via a first display terminal (such as a mobile phone), and the multimedia content of the webpage to be outputted to a second display terminal for display.

### FIELD OF THE INVENTION

The present invention relates to communication field, particularly to a webpage data processing method and device.

### BACKGROUND OF THE INVENTION

Currently, almost every hand-held intelligent device such as mobilephones, a personal digital assistant (hereinafter referred to as PDA for short), a laptop, and a hand-held game console with the application of web browser. The conventional webpage has embedded some multimedia content such as images, video, or audio. The multimedia content will be directly displayed and shown on webpage when using the hand-held intelligent device to browse to the webpage. However, due to relatively lower of the speaker volume and relatively poorer of volume effect, it is difficult to have a pleasure as that of watching the multimedia content from a big screen. Some solutions for hand-held intelligent devices interacting with big screens are appeared in the market, for example, transporting the webpage browsed in the mobilephone or PDA to a television for display. The disadvantage is like causing the hybrid of the text content and multimedia content during transporting the webpage to the television, thus causing a screen inconsistency when the television displays the hybrid of the text content and multimedia content.

The aforementioned is just for understanding the present invention, but not the prior art.

### SUMMARY OF THE INVENTION

The present invention aims to solve a screen inconsistency when a webpage having multimedia content such as images, video or audio is being browsed via a display terminal.

The present invention provides a webpage data processing method including steps of a first display terminal sending a webpage link request to a server to obtain webpage content included in the webpage link; the first display terminal classifying the obtained webpage content according to the type of the webpage content into a first preset type of webpage content and a second preset type of webpage content; the first preset type having images, video or audio; the second preset type having texts; the first display terminal outputting the first preset type of webpage content to a second display terminal for display; the first display terminal displaying the second preset type of webpage content.

Preferably, the first display terminal sending a webpage link request to a server to obtain webpage content included in the webpage link including: the first display terminal sending the webpage link request to the server; the first display terminal receiving the HTML script file from the server according to the webpage link request; the first display terminal obtaining all the webpage content from the HTML script file.

Preferably, the first display terminal classifying the obtained webpage content according to the type of the webpage content into a first preset type of webpage content and a second preset type of webpage content, including: the first display terminal successively reads the HTML script file of webpage content and corresponding tags that are configured for identifying the type of webpage content; the first display terminal determines whether the webpage content is the first preset type of webpage content according to currently read tags; if the webpage content is the first preset type of webpage content, the first display terminal stores the URL link address of current read webpage content to a preset list, then deleting the currently read webpage content and tags of HTML script file; until all the webpage content has been read, the first display terminal re-structures the HTML script file to a new HTML script file; the first display terminal outputs the first preset of webpage content to the second display terminal for display, specifically, the first display terminal outputs the preset list to the second display terminal for display; the first display terminal displays the second preset of webpage content, specifically the first display terminal loads the new HTML script file by a web browser.

Preferably, the tags including images, video, audio, format of emb. and object.; when the tag corresponding to currently read webpage content is in format of emb. or object., the first display terminal determines whether the currently read webpage content is the first preset of webpage content according to the format of embedded object in the webpage content.

Preferably, the first display terminal outputs the preset list to the second display terminal for display, specifically after the first display terminal outputs the preset list to the second display terminal, the second display terminal loads the URL link address in the preset list.

Preferably, the second display terminal decodes and plays the first preset type of webpage content obtained by loading the URL link address in the preset list.

Furthermore, the present invention provides a webpage data processing device including a webpage obtaining module for sending a webpage link request to a server to obtain webpage content included in the webpage link; a webpage processing module for classifying the obtained webpage content according to the type of webpage content into a first preset type of webpage content and a second preset type of webpage content; the first preset type having webpage content such as images, video or audio and the second preset type having webpage content such as text; an outputting module for outputting the first preset type of webpage content to the second display terminal for display; and a display module for displaying the second preset type of webpage content.

Preferably, the webpage obtaining module includes a sending unit for sending the webpage link request to the server; a receiving unit for receiving the feedback HTML script file according to the webpage link request; and an obtaining unit for obtaining the HTML script file of webpage content.

Preferably, the webpage processing module includes a reading unit, for successively reading the HTML script file of webpage content and corresponding tags that are configured for identifying the type of webpage content; a first determining unit, for determining whether the webpage content is the first preset type of webpage content according to currently read tags; an URL address taking unit for if the currently read webpage content is the first preset type of webpage content, the first display terminal stores an URL link address of the currently read webpage content to a preset list, then deleting the currently read webpage content and tags included in the HTML script file; and a script file re-structure unit, for until all the webpage content has been read, re-structuring the HTML script file to a new HTML script file.

Preferably, the tags include images, video, audio, format of emb. and object. The webpage processing module further includes a second determining unit, for when the tag corresponding to the currently read webpage content is in the format of emb. or object., determining whether the read webpage content is the first preset of webpage content according to the format of embedded object in the webpage content.

Preferably, the displaying module is configured for enabling a browser to load the HTML script file; the outputting module is configured for outputting the preset list to the second display terminal, thus the second display terminal loads the URL link address in the preset list.

Preferably, the second display terminal decodes and plays the first preset type of webpage content obtained by loading the URL link address in the preset list.

The webpage data processing method of the present invention classifies the webpage content into the first preset type of webpage content and the second preset type of webpage content. The first preset type of webpage content has multimedia content such as images, video or audio, which is outputted to the second display terminal for display. The second preset type of webpage content has multimedia content such as text, which is being browsed via the first display terminal. That means, the first display terminal only displays the text content of the webpage, and the second display terminal only displays image, video or audio content, thus avoiding the screen inconsistency when the webpage having multimedia content such as images, video or audio is being browsed via the first display terminal or the second display terminal, further avoiding when the first display terminal is a hand-held intelligent terminal, due to a relatively small screen of the hand-held intelligent terminal, it is difficult to watch the video content as well as the text content in the screen, thus improving user experience.

### BRIEF DESCRIPTION OF THE DRAWINGS

FIG. 1 is a flowchart of the webpage data processing method according to a first embodiment of the present invention;

FIG. 2 is a flowchart of the webpage data processing method according to a second embodiment of the present invention;

FIG. 3 is a flowchart of the webpage data processing method according to a third embodiment of the present invention;

FIG. 4 is a schematic view of the webpage data processing device according to a first embodiment of the present invention;

FIG. 5 is a schematic view of the webpage obtaining module in FIG. 4;

FIG. 6 is a schematic view of the webpage processing module in FIG. 4.

There and other features, aspects, and advantages of disclosure will be apparent to those skilled in the art from the following detailed description of embodiments, taken together with the drawings and the claims that follow.

### DETAILED DESCRIPTION OF THE EMBODIMENTS

It should be understood that the specific embodiments described herein are merely used for describing the present invention, but are not intended to limit the present invention.

The present invention provides a webpage data processing method.

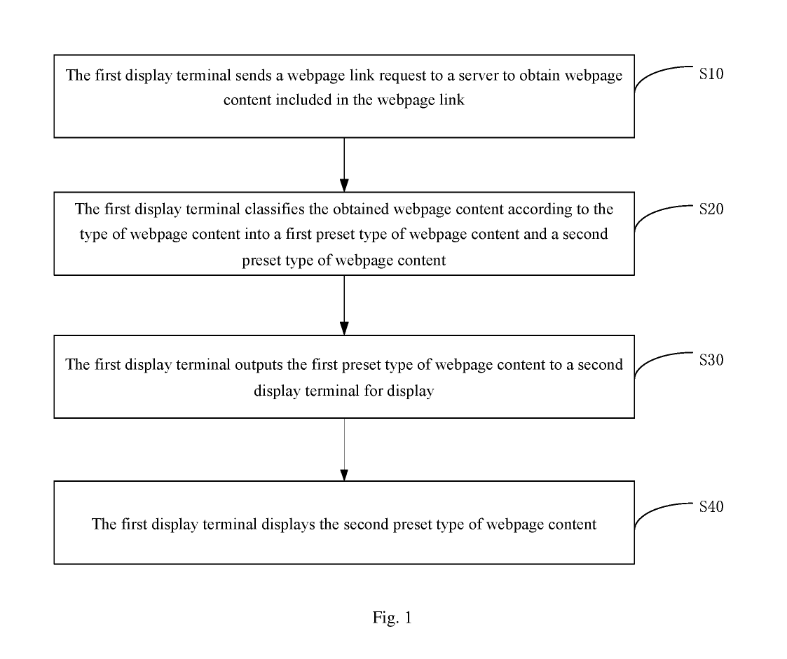

With reference to FIG. 1, FIG. 1 is a flowchart of the webpage data processing method according to a first embodiment of the present invention.

In the first embodiment, the webpage data processing method includes:

Step 10: a first display terminal sends a webpage link request to a server to obtain webpage content included in the webpage link.

In the embodiment, the first display terminal receives the webpage link request inputted by users, then accessing the server according to webpage link request, obtaining the webpage content from Internet via the server meanwhile temporarily storing the webpage content to a memory. In the embodiment of the present invention, the first display terminal usually is hand-held intelligent terminals with application of a web browser that may be but not limited to a mobilephone, a PDA, a laptop, a hand-held game console and so on.

Step 20: the first display terminal classifies the obtained webpage content according to the type of the webpage content into a first preset type of webpage content and a second preset type of webpage content.

In the embodiment, first, the first display terminal reads the obtained webpage content having multimedia content such as images, video, audio or text from a memory or a storage device, then classifying the type of the obtained webpage content. The types of the obtained webpage content like images, video, audio will be detached to form the first preset type of webpage content, and the type of the obtained webpage content like text will form the second preset type of webpage content. Therefore, the webpage content is divided into the first preset type of webpage content having images, video or audio and the second preset type of webpage content having text.

Step 30: the first display terminal sends the first preset type of webpage content to the second preset type of webpage content.

Step 40, the first display terminal displays the second preset type of webpage content.

In the embodiment of the present invention, the second display terminal usually has a relatively big screen, such as a television. The first display terminal may instantly communicate with the second display terminal. The specific communication methods may be but not limited to wired local area network, WiFi local area network, wired internet, WiFi internet, WiFi hotspot, 2G/3G/4G wireless communications network, bluetooth, Near Field Communication (NFC for short), infrared and so on. The first display terminal classifies the obtained webpage content to the first preset type of webpage content having images, video or audio and the second preset type of webpage content having text. Then the first display terminal outputs the first preset type of webpage content to the second display terminal for display, at the same time, users may enable the first display terminal display a webpage without multimedia content such as images, video or audio. The first display terminal such as mobilephones may display organized text type of webpage content and the second display terminal such as a television may display the multimedia content including images, video and/or audio, without text type of webpage content, avoiding a screen inconsistency when the second display terminal is displaying the multimedia content, avoiding chaos of the screen.

The webpage data processing method of the present invention classifies the obtained webpage content to the first preset type of webpage content having images, video or audio and the second preset type of webpage content having text. Of which, the second preset type of webpage content having text may be browsed via the first display terminal. The first type of webpage content having images, video or audio may be outputted to the second display terminal for display. That means, users can only review the text type of webpage content on the first display terminal and the images, video or audio type of webpage content on the second display terminal, therefore avoiding the screen inconsistency when a webpage having multimedia content such as images, video or audio is being browsed via the first display terminal or the second display terminal, further avoiding when the first display terminal is a hand-held intelligent terminal, due to a relatively small screen of the hand-held intelligent terminal, it is difficult to watch the video content as well as the text content in the screen, thus improving user experience.

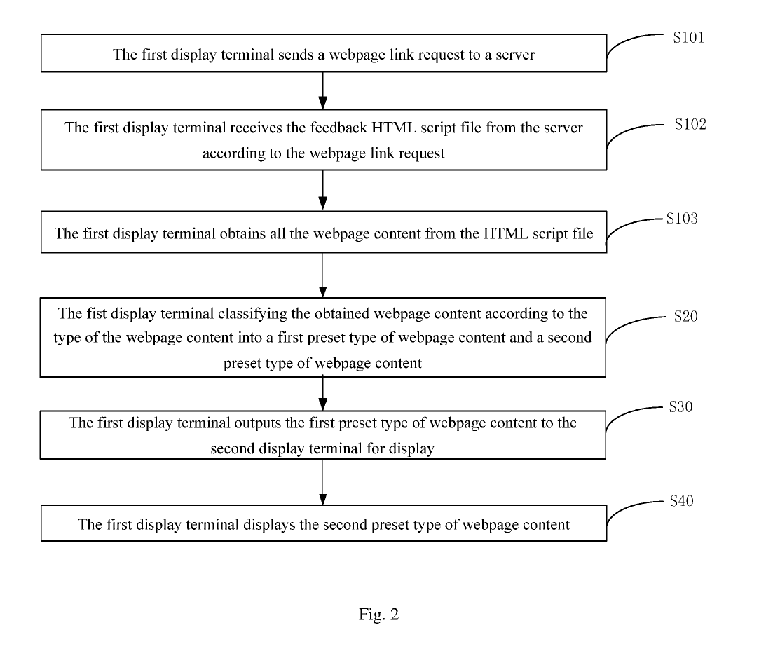

With reference to FIG. 2, FIG. 2 is a flowchart of the webpage data processing method according to a second embodiment of the present invention.

According to the first embodiment of the present invention, furthermore, the step 10 comprises: step S101: the first display terminal sends a webpage link request to a server; step S102, the first display terminal receives the feedback HTML script file according to the webpage link request; step S103, the first display terminal obtains all the webpage content included in the HTML script file.

In the embodiment of the present invention, before users browse the webpage via the first display terminal, the first display terminal receives the webpage link request inputted by users, such as a webpage link or a hyperlink connection among webpage; then accessing the server according to the webpage link request, the server feedbacks corresponding HTML script file to the first display terminal via HTTP protocols, the first display terminal obtains the webpage content of the feedback HTML script file. In the embodiment, the HTML script file is composed by multiple tags and contents included in tags.

It needs to be emphasized, in other embodiments of the present invention, the feedback content of the server feedbacks content via the webpage link request may be but not limited in the format of Hypertext Preprocessor (PHP for short), Java Server Pages(Java for short), Active

Server Page (ASP for short), Common Gateway Interface (CGI for short).

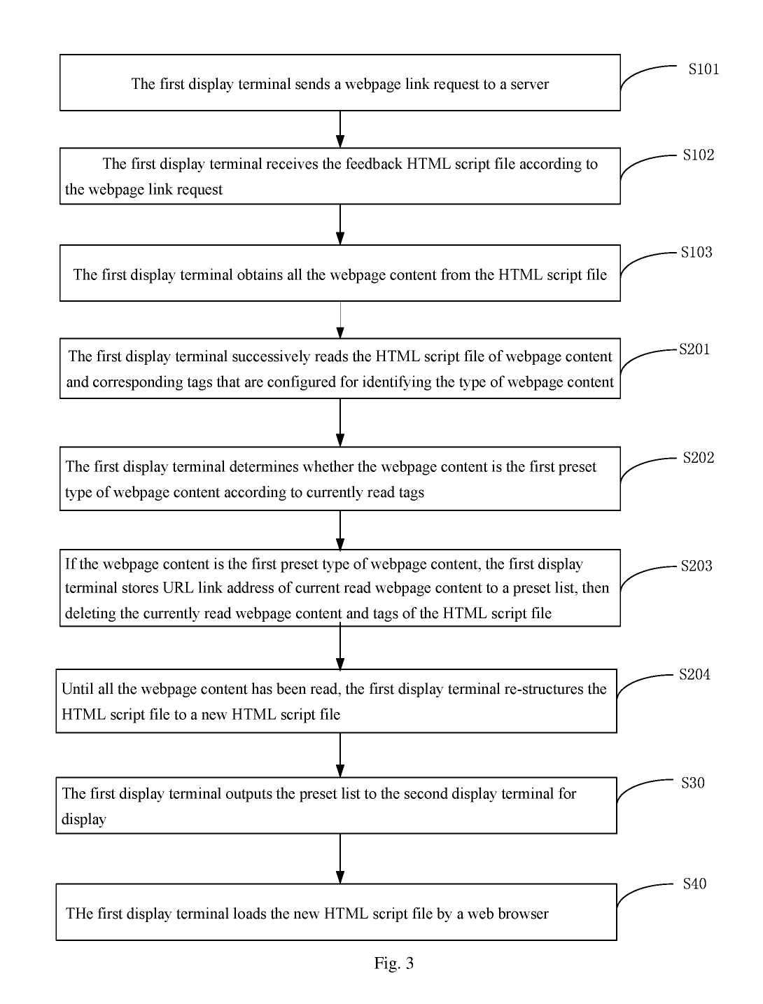

With reference to FIG. 3, FIG. 3 is a flowchart of the webpage data processing method according to a third embodiment of the present invention.

In the second embodiment of the present invention, the step S20 specifically comprises: step S201, the first display terminal successively reads webpage content and corresponding tags included in the HTML script file. In the embodiment of the present invention, before the first display terminal classifies the obtained webpage content, the first display terminal successively reads webpage content and corresponding tags included in the feedback HTML script file. Different tag represents for different webpage content.

Step S202, the first display terminal determines whether the currently read webpage content is the first preset type of webpage content according to the corresponding tags of currently read webpage content. If yes, performing step S203. In the embodiment, the first display terminal determines whether currently read webpage content is images, video or audio according to the corresponding tags of currently read webpage content. That means, the embodiment of the present invention determines webpage content is multimedia content or text content via analyzing the type of every corresponding tag. Specifically, the tags of the HTML script file comprise images, audio, video, format of emb. or object. Of which, the picture content is shown by images. It needs to be noticed, in terms of different HTML script files, the tag representing for video type content is different. For the version of HTML5 script file, the tag representing for audio type is audio, the tag representing for video type content is video. Whereas for the previous version of HTML script file, the tag in the format of emb. or object. may represent for video type content. At that time, by analyzing the format of embedded object of webpage content corresponding to the tag in the format of emb. or object., determining whether the tag represents for video type content. When the embedded object is in a video format of AVI, SWF, FLU or 3 GP, then the tag in the format of emb. or object. represents for video type content.

Step S203, the first display terminal stores URL link address of the currently read webpage content to the preset list, then deleting the currently read webpage content and tags included in the HTML script file. In the embodiment, when the currently read webpage content is the first preset type of webpage content, taking the URL link address from the currently read webpage content and storing the URL link address to the preset list, then deleting currently read webpage content and tags included in the HTML script file.

Step S204, until all of the webpage content has been read, re-structuring the HTML script file to a new HTML script file. In the embodiment of the present invention, the first display terminal successively reads all of the webpage content and corresponding tags included in the HTML script file, until all of the webpage content has been read, re-structuring the deleted first preset type of webpage content and corresponding tags and remaining the HTML script file to the new HTML script file which only includes text content, therefore obtaining the new HTML script file only including text content.

In the embodiment of the present invention, step S30 is the first display terminal outputting the preset list to the second display terminal for display. More specifically, the second display terminal may access the Internet, the first display terminal outputs the preset list to the second display terminal (such as a television), the preset list comprises the URL link address of the first preset type of webpage content. Then the second display terminal loads corresponding URL link address to display the first preset type of webpage content. The second display terminal may directly decode and display multimedia content having images, video or audio corresponding to the URL link address.

Due to the amount of data for encoded multimedia content such as images, video or audio is large, if the first display terminal sends the encoded multimedia content to the second display terminal for display. The sending process may easily cause network congestion, as a result, the display image of the second display terminal has a phenomenon of delay. In the embodiment, the second display terminal loads corresponding URL link address according to the preset list received by the second display terminal, directly obtaining webpage content from the Internet for decoding and display, under the normal net speed, avoiding the second display terminal having the phenomenon of delay because of network congestion. Meanwhile, since video type of webpage content is usually horizontal and relatively big second display screen, such as the television is usually horizontal, that means, the video type of webpage content may be more adaptive for display, therefore improving user experience.

In the embodiment, Step S40 specifically is that the first display terminal displays the second preset type of webpage content. Since the new HTML script file only comprises the second preset type of webpage content, in the embodiment, the first display terminal only displays text type of webpage content when enabling the browser to load the new HTML script file. Thus, the first display terminal such as mobilephones may be highly organized to show text type of webpage content, when the first display terminal is a hand-held intelligent terminal, avoiding the hand-held intelligent terminal with a relatively smaller screen displays the multimedia content having images, video and/or audio, and text type of webpage content, meanwhile avoiding chaos of the screen.

According to the embodiment of the present invention, the URL link address included in the first preset type of webpage content is taken to form a preset list sent to the second display terminal. On the one hand, the small amount of date in the preset list may save interactive flow between the first display terminal and second display terminal, on the other hand, the first display terminal has no need to encode the webpage content having images, video or audio, and no need to send the encoded webpage content to the second display terminal, therefore avoiding intensive consumption of the battery when the first display terminal such as the mobilephone is doing long time decoding operation.

The present invention further provides a webpage data processing device.

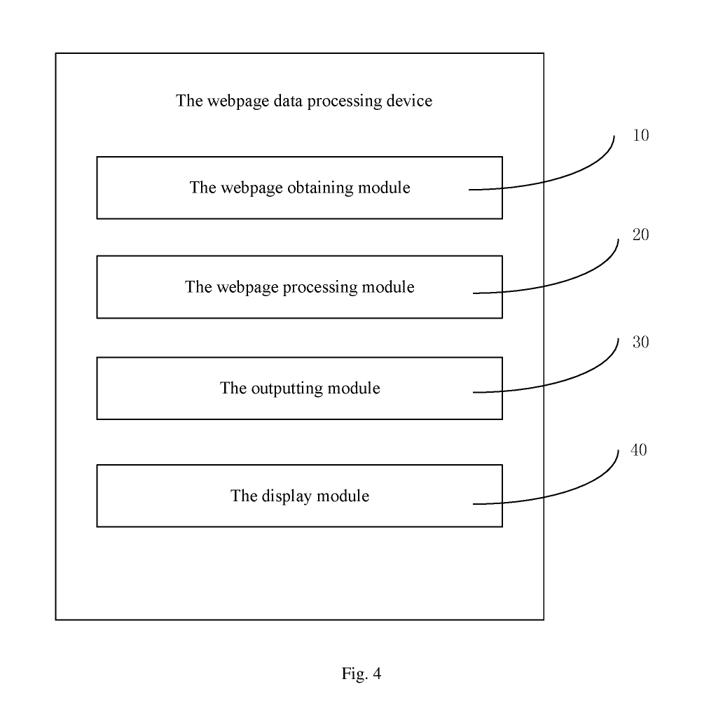

With reference to FIG. 4, FIG. 4 is a schematic view of the webpage data processing device according to a first embodiment of the present invention.

In the embodiment, the webpage data processing device comprises a webpage obtaining module 10, a webpage processing module 20, an outputting module 30, a display module 40. Of which, the webpage obtaining module 10 is configured for sending a webpage link request to a server to obtain webpage content included in the webpage link; the webpage processing module 20 is configured for classifying the obtained webpage content according to the type of webpage content into a first preset type of webpage content and a second preset type of webpage content; the first preset type has webpage content such as images, video or audio and the second preset type has webpage content such as text.

The outputting module 30 is configured for outputting the first preset type of webpage content to the second display terminal for display.

The display module 40 is configured for displaying the second preset type of webpage content.

In the embodiment, the webpage obtaining module 10 receives webpage link request inputted by users, then accessing the server according to the webpage link request, obtaining the webpage content from Internet via the server meanwhile temporarily storing the webpage content to a memory or a local storage device. The webpage processing module 20 reads all of the types of webpage content from the memory or local storage device. The type of webpage content comprises images, video or audio as well as text. Then the webpage content is classified into the first preset type of webpage content having multimedia content such as images, video or audio. The text type of webpage content is re-structured as the second type of webpage content.

Therefore, all of the webpage content is divided into the first preset type of webpage content having images, video or audio and the second preset type of webpage content having text content. The outputting module 30 outputs the first preset type of webpage content to the second preset type of webpage content for display. Meanwhile, users may review the webpage content excluding images, video or audio via the display module 40. In the embodiment, the webpage data processing device is located on the first display terminal, and the first display terminal usually means the hand-held intelligent terminal, such as mobilephones, a PDA, a laptop, a handheld game console. The second display terminal usually means some display terminals with a relatively big screen, such as the television. The first display terminal and second display terminal may instantly be communicated with each other.

The webpage data processing device of the present invention classifies the webpage content into the first preset type of webpage content having images, video or audio and the second preset type of webpage content having text. Of which, the second preset type of webpage content having text content may be browsed via the display module 40. And the first preset type of webpage content having images, video or audio may be outputted to the second display terminal for display. Therefore, the display module 40 only browses text content, and the second display terminal only display images, video or audio type content. And the webpage data processing device is located on the first display terminal, avoiding the screen inconsistency when the webpage having multimedia content such as images, video or audio is being browsed via the first display terminal or the second display terminal. When the first display terminal is a hand-held intelligent terminal, avoiding the hand-held intelligent terminal with relatively small screen displays the multimedia content having images, video and/or audio, as well as text type of webpage content, and avoiding chaos of the screen.

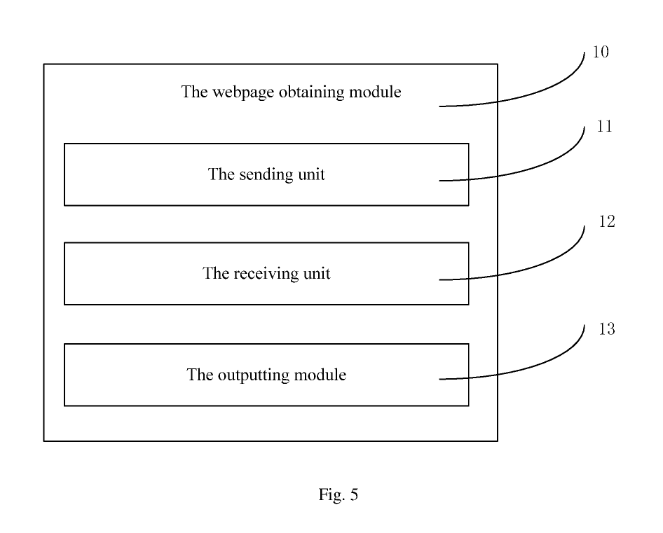

With reference to FIG. 5, furthermore, the webpage obtaining module 10 comprises: a sending unit 11 for sending the webpage link request to the server; a receiving unit 12 for receiving the feedback HTML script file according to the webpage link request; an obtaining unit 13 for obtaining the HTML script file of webpage content.

In the embodiment, before users browses the webpage via the first display terminal, the sending unit 11 receives the webpage link request inputted by users, such as a webpage link or a hyperlink connection among webpage, then accessing the server according to webpage link request. The receiving unit 12 receives the feedback HTML script file to the first display terminal via HTTP protocols. The obtaining unit 13 obtains the webpage content of the feedback HTML script file. In the embodiment, the HTML script file is composed by multiple tags and contents included in tags.

It needs to be emphasized, in other embodiments of the present invention, the feedback content of the server sending via the webpage link request may be but not limited in the format of Hypertext Preprocessor (PHP for short), Java Server Pages(Java for short), Active Server Page (ASP for short), Common Gateway Interface (CGI for short).

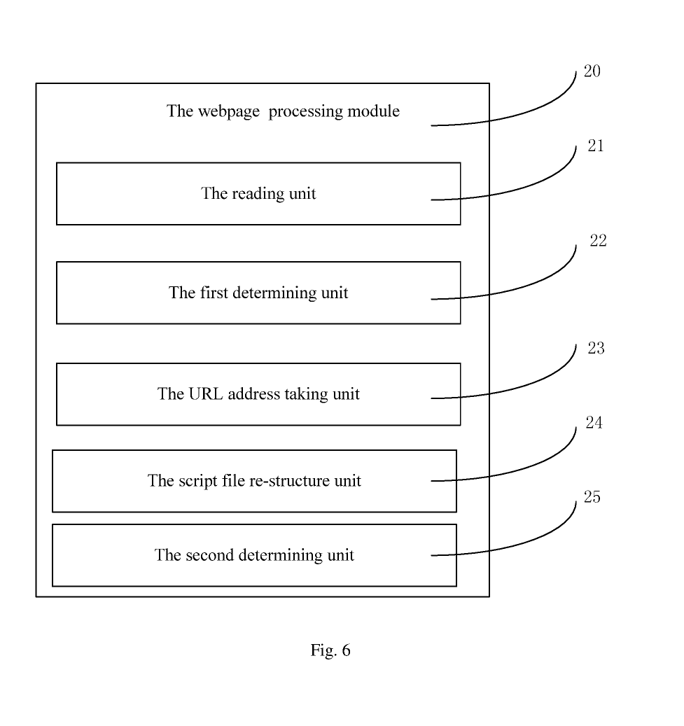

Referring to FIG. 6, furthermore, the webpage processing module 20 comprises: a reading unit 21, for successively reading the HTML script file of webpage content and corresponding tags that are configured for identifying the type of webpage content; a first determining unit 22, for determining whether the webpage content is the first preset type of webpage content according to currently read tags; a URL address taking unit 23 for if the currently read webpage content is the first preset type of webpage content, the first display terminal stores URL link address of the currently read webpage content to a preset list, then deleting the currently read webpage content and tags included in the HTML script file; a script file re-structure unit 24, for until all the webpage content has been read, re-structuring the HTML script file to a new HTML script file; a second determining unit 25, for when the tag corresponding to the currently read webpage content is in format of emb. or object., determining whether the read webpage content is the first preset of webpage content according to the format of embedded object in the webpage content.

In the embodiment, when the webpage processing module 20 classifies the obtained webpage content. The reading unit 21 successively read the HTML script file of webpage content and corresponding tags that are configured for identifying the type of webpage content. That means different tag means different type of webpage content. The first determining unit 22 determines whether the webpage content has multimedia content such as images, video or audio. That is, the first determining unit 22 analyses and compares every tag to determine whether the webpage content corresponding to tags is multimedia content or text content. Then, when the currently read webpage content is the first preset type of webpage content, the URL address taking unit 23 takes URL link address of currently read webpage content and stores the URL link address of currently read webpage content to the preset list, then deleting the currently read webpage content and tags of the HTML script file. That is the URL address taking unit 23 takes currently read webpage content from the HTML script file, to get rid of the first preset type of webpage content and corresponding tags from the HTML script file. Until all the webpage content has been read, the script file re-structure unit 24 re-structures the HTML script file being got rid of the first preset type of webpage content and corresponding tags and remain HTML script file to a new HTML script file, therefore, the new HTML script file only includes the second preset type of webpage content.

In the embodiment, specifically, the tags of HTML script file comprise images, audio, video, format of emb. or object. Of which, the picture content is shown by image. It needs to be noticed, in terms of different HTML script file, the tag representing for video type content is different. For the version of HTML5 script file, the tag representing for audio type is audio, the tag representing for video type content is video. Whereas for the previous version of HTML script file, the tag in the format of emb. or object. may represent for video type content. At that time, by analyzing the format of embedded object of webpage content corresponding to the tag in the format of emb. or object., the second determining unit 25 determines whether the tag represents for video type content. When the embedded object is in video format of AVI, SWF, FLU or 3 GP, then the tag in the format of emb. or object. represents for video type content.

In the embodiment, the outputting module 30 of the webpage data processing device is configured for outputting the preset list to the second display terminal for display. More specifically, in the embodiment, the second display terminal may access the Internet, the outputting module 30 of the webpage data processing device outputs the preset list to the second display terminal (such as a television), the preset list comprises the URL link address of the first preset type of webpage content. Then the second display terminal loads corresponding URL link address to display the first preset type of webpage content. The second display terminal may directly decode and display multimedia content having images, video or audio corresponding to the URL link address.

In the embodiment, the display module 40 of the webpage data processing device is configured for obtaining the new HTML script file loaded by the web browser. Since the new HTML script file only comprises the second preset type of webpage content. In the embodiment, the first display terminal only displays text type of webpage content when the display module 40 enables the browser to load the new HTML script file, displaying only the text content. Thus, the first display terminal such as mobilephones may be highly organized to show text type of webpage content.

In the embodiment, the URL link address taking module 23 takes the URL link address corresponding to the first type of webpage content to form the preset list and then sent to the second display terminal. On the one hand, the small amount of date in the preset list may save interactive flow between the first display terminal and second display terminal, on the other hand, the first display terminal has no need to encode the webpage content having images, video or audio and send the encoded webpage content to the second display terminal, avoiding intensive consumption of the battery when the first display terminal such as the mobilephone is doing long time decoding operation.

The foregoing descriptions are merely embodiments of the present invention, and are not intended to limit the scope of the present invention. An equivalent structural or equivalent process alternation made by using the content of the specification and drawings of the present disclosure, or an application of the content of the specification and drawings directly or indirectly to another related technical field, shall fall within the protection scope of the present invention.

What is claimed is:

1. A webpage data processing method, comprises steps of:
a first display terminal sending a webpage link request to a server to obtain webpage content included in the webpage link;
the first display terminal classifying the obtained webpage content according to the type of the webpage content into a first preset type of webpage content and a second preset type of webpage content; the first preset type having images, video or audio; the second preset type having texts;
the first display terminal outputting the first preset type of webpage content to a second display terminal for display; and
the first display terminal displaying the second preset type of webpage content.

2. The webpage data processing method of claim 1, wherein a first display terminal sending a webpage link request to a server to obtain webpage content included in the webpage link comprises:
the first display terminal sending the webpage link request to the server;
the first display terminal receiving feedback HTML script file from the server according to the webpage link request; and
the first display terminal obtaining all the webpage content from the HTML script file.

3. The webpage data processing method of claim 2, wherein the first display terminal classifying the obtained webpage content according to the type of the webpage content into a first preset type of webpage content and a second preset type of webpage content, comprises:
the first display terminal successively reads the HTML script file of webpage content and corresponding tags that are configured for identifying the type of webpage content;
the first display terminal determines whether the webpage content is the first preset type of webpage content according to currently read tags;
if the webpage content is the first preset type of webpage content, the first display terminal stores URL link address of current read webpage content to a preset list, then deleting the currently read webpage content and tags of the HTML script file;
until all the webpage content has been read, the first display terminal re-structures the HTML script file to a new HTML script file;
the first display terminal outputs the first preset of webpage content to the second display terminal for display, specifically, the first display terminal outputs the preset list to the second display terminal for display; and
the first display terminal displays the second preset of webpage content, specifically the first display terminal loads the new HTML script file by a web browser.

4. The webpage data processing method of claim 3, wherein, the tags comprises images, video, audio, format of emb. or object.;
when the tag corresponding to currently read webpage content is in format of emb. or object., the first display terminal determines whether the currently read webpage content is the first preset of webpage content according to the format of embedded object in the webpage content.

5. The webpage data processing method of claim 3, wherein, the first display terminal outputs the preset list to the second display terminal for display, specifically the first display terminal outputs the preset list to the second display terminal, for the second display terminal to load the URL link address in the preset list.

6. The webpage data processing method of claim 5, wherein, the second display terminal decodes and plays the first preset type of webpage content obtained by loading URL link address in the preset list.

7. The webpage data processing method of claim 4, wherein the first display terminal outputs the preset list to the second display terminal, specifically the first display terminal outputs the preset list to the second display terminal, for the second display terminal to load the URL link address in the preset list.

8. A webpage data processing device comprises:
a webpage obtaining module, for sending a webpage link request to a server to obtain webpage content included in the webpage link;
a webpage processing module, for classifying the obtained webpage content according to the type of webpage content into a first preset type of webpage content and a second preset type of webpage content; the first preset type having webpage content such as images, video or audio and the second preset type having webpage content such as text;
an outputting module for outputting the first preset type of webpage content to the second display terminal for display; and
a display module for displaying the second preset type of webpage content.

9. The webpage data processing device of claim 8, wherein the webpage obtaining module comprises:
a sending unit for sending the webpage link request to the server;
a receiving unit for receiving the feedback HTML script file according to the webpage link request; and
an obtaining unit for obtaining the HTML script file of webpage content.

10. The webpage data processing device of claim 9, wherein the webpage processing module comprises:
a reading unit, for successively reading the HTML script file of webpage content and corresponding tags that are configured for identifying the type of webpage content;
a first determining unit, for determining whether the webpage content is the first preset type of webpage content according to currently read tags;
an URL address taking unit, for if the currently read webpage content is the first preset type of webpage content, the first display terminal stores URL link address of the currently read webpage content to a preset list, then deleting the currently read webpage content and tags included in the HTML script file; and
a script file re-structure unit, for until all the webpage content has been read, re-structuring the HTML script file to a new HTML script file.

11. The webpage data processing device of claim 10, wherein, the tags comprise images, video, audio, format of emb. or object.;
the webpage processing module further comprises a second determining unit, for when the tag corresponding to the currently read webpage content is in format of emb. or object., determining whether the read webpage content is the first preset of webpage content according to the format of embedded object in the webpage content.

12. The webpage data processing device of claim 10, wherein, the displaying module is configured for enabling a web browser to load the HTML script file; the outputting module is configured for outputting the preset list to the second display terminal, thus the second display terminal loads URL link address in the preset list.

13. The webpage data processing device of claim 12, wherein the second display terminal decodes and plays the first preset type of webpage content obtained by loading the URL link address in the preset list.

14. The webpage data processing device of claim 11, wherein the displaying module is configured for enabling a browser to load the HTML script file; the output module is configured for outputting the preset list to the second display terminal, thus the second display terminal loads the URL link address in the preset list.
